(19) United States
(12) Patent Application Publication
(10) Pub. No.: US 2013/0260043 A1
(43) Pub. Date: Oct. 3, 2013

(54) METHOD OF COATING A GEOPOLYMER ONTO AN ARTICLE

(71) Applicants: Mohd Mustafa Al Bakri Abdullah, Perlis (MY); Mohammad Tamizi Selimin, Perlis (MY); Kamarudin Hussin, Perlis (MY); Che Mohd Ruzaidi Ghazali, Perlis (MY); Liyana Jamaludin, Perlis (MY); Norazian Mohamad Noor, Perlis (MY); Rafiza Abdul Razak, Perlis (MY); Zarina Yahya, Perlis (MY); Muhd Izzat Ahmad, Perlis (MY); Abdulaziz A. Kurdi, Riyadh (SA); Bader Z. Juwayr, Riyadh (SA); Mohammed Binhussain, Riyadh (SA)

(72) Inventors: Mohd Mustafa Al Bakri Abdullah, Perlis (MY); Mohammad Tamizi Selimin, Perlis (MY); Kamarudin Hussin, Perlis (MY); Che Mohd Ruzaidi Ghazali, Perlis (MY); Liyana Jamaludin, Perlis (MY); Norazian Mohamad Noor, Perlis (MY); Rafiza Abdul Razak, Perlis (MY); Zarina Yahya, Perlis (MY); Muhd Izzat Ahmad, Perlis (MY); Abdulaziz A. Kurdi, Riyadh (SA); Bader Z. Juwayr, Riyadh (SA); Mohammed Binhussain, Riyadh (SA)

(21) Appl. No.: 13/656,762

(22) Filed: Oct. 22, 2012

(30) Foreign Application Priority Data
Mar. 29, 2012 (MY) PI 2012700134

(51) Int. Cl. B05D 7/24; B05D 3/02

(52) U.S. Cl. 427/397.7

(57) ABSTRACT

A method of coating a geopolymer onto an article that is made of high heat applicable material, the method comprising the steps of providing geopolymer paste prepared from reacting fly ash-derived pozzolanic material with an alkaline activator solution; coating the geopolymer paste onto the article; curing the coated article; and sintering the cured article at a temperature ranging from 100° C. to 1500° C.

### CLAIM OF PRIORITY

This utility patent application claims priority from and incorporates by reference in its entirety, Malaysian Application No. PI 2012700134 titled: “A Method of Coating a Geopolymer onto an Article” filed on Mar. 29, 2012.

### FIELD OF TECHNOLOGY

This claimed invention relates to a method for coating a geopolymer onto an article. In particular, this claimed invention relates to a method for coating a geopolymer onto the article, the geopolymer has high fire and erosion resistance and high mechanical strength.

### BACKGROUND

Surface deterioration of concrete, metal or clay caused by high heat, chemicals or abrasion is becoming one of the major problems for durability of structures made by these materials. The surface deterioration could develop into structural problems, especially in reinforced concrete, metal or clay structural elements. Prevention of liquid ingress into concrete or clay structures is desired, thus preventing the ingress of chemicals such as chloride from salts and subsequent deterioration. Many approaches have been made to enhance reinforcement or prevent corrosion of these materials. Geopolymer is an alternative pozzolanic material that has ceramic-like properties. Geopolymers are a class of materials that are formed by chemical dissolution and subsequent recondensation of various aluminosilicate oxides and silicates to form an amorphous three-dimensional framework structure. Pozzolanic material is siliceous or silicious and aluminous material which, in itself, possesses little or no cementitious value, but which will, in finely divided form and in the presence of water, react chemically with calcium hydroxide at ordinary temperature to form compounds possessing cementitious properties.

Geopolymer technology has the potential to reduce emissions by 80% because high temperature calcining is not required. It also exhibits ceramic-like properties with good resistance to fire at elevated temperatures. Geopolymers have amorphous to semi-crystalline structures, equivalent to certain zeolitic materials with excellent properties such as high fire and erosion resistance and high mechanical strength. Materials that produce geopolymer include fly ash, which refers to the inorganic, incombustible matter present in coal that is fused into a glassy amorphous structure during the combustion process.

There are some patented and patent application pending technologies which disclose methods for producing geoplymer composite material. Of interest is U.S. Pat. No. 7,745,363 which discloses a geopolymer composite material having low coefficient of thermal expansion and high strength. The geopolymer material may be used without pre-firing, with pre-firing to about 300° C. or with firing at relatively low temperatures to provide acid resistance and inhibit cracking during shrinkage. However, the geopolymer material does not contain fly ash.

U.S. Patent Document No. US 2007/011221100(A1) discloses a process for preparing a self-glazed geopolymer tile using fly ash and granulated blast furnace slag. However, the fly ash is mixed with the granulated blast furnace slag and alkaline activator solution and cured at a temperatures ranging from 50° C. to 350° C. to obtain the geopolymer tile without subjecting it to a sintering process.

Therefore, a strong need exists for the development of a coating which is protective against heat, chemicals, and abrasion; while compatible with concrete, metals or clay materials. The coating is desired for an increased compressive strength and chemical resistance that uses recycled fly ash in its manufacturing process.

### SUMMARY

The primary object of the present claimed invention is to provide a solution to minimize surface deterioration of articles made by concrete, metal or clay and capable of withstanding severe exposure conditions such as high heat and chemical corrosion.

Another object of the present claimed invention is to provide a method that uses a fly-ash based geopolymer as a coating for the article.

At least one of the proceeding objects is met, in whole or in part, by the present claimed invention, in which the preferred embodiment of the present claimed invention describes a method for coating a geopolymer onto an article that is made of high heat applicable material, the method comprising the steps of providing geopolymer paste prepared from reacting fly ash-derived pozzolanic material with an alkaline activator solution; coating the geopolymer paste onto the article; curing the coated article; and sintering the cured article at a temperature ranging from 100° C. to 1500° C.

One of the embodiments of the present claimed invention discloses that the method further comprises providing a clay-based pozzolanic material, a volcano mud-based pozzolanic material, a marine clay-based pozzolanic material or a combination thereof to the fly ash-derived pozzolanic material prior to reacting with the alkaline activator solution.

Another embodiment of the present claimed invention discloses that the high heat applicable material is concrete, clay, ceramic, metal or alloy.

Another embodiment of the present claimed invention discloses that the geopolymer coated article is cured at temperatures ranging from 60° C. to 75° C.

Another embodiment of the present claimed invention describes that the sintering process of the cured article has heating and cooling rates ranging from 3° C./minutes to 8° C./minutes.

Yet another embodiment of the present claimed invention describes that the concentration ratio between pozzolanic material to alkaline activator is 2.5-3.5:1.

Another embodiment of the present claimed invention describes that the alkaline activator solution is formed by sodium silicate and sodium hydroxide.

A further embodiment of the present claimed invention discloses that the sodium silicate consists of 8-10% of sodium oxide, 25-35% of silicon dioxide, and 55-65% of water.

A particular embodiment of the present claimed invention discloses that the sintered article has a compressive strength ranging from 14 MPa to 45 MPa.

The present preferred embodiment of the claimed invention consists of novel features and a combination of parts hereinafter fully described and illustrated in the accompanying drawings and particularly pointed out in the appended claims; it being understood that various changes in the details may be effected by those skilled in the arts but without departing from the scope of the claimed invention or sacrificing any of the advantages of the present claimed invention.

### DETAILED DESCRIPTION

Hereinafter, the claimed invention shall be described according to the preferred embodiments of the present claimed invention and by referring to the accompanying description and drawings. However, it is to be understood that limiting the description to the preferred embodiments of the claimed invention and to the drawings is merely to facilitate discussion of the present claimed invention and it is envisioned that those skilled in the art may devise various modifications without departing from the scope of the appended claim.

The present claimed invention relates to a method for coating a geopolymer onto an article. Geopolymers are a class of three-dimensionally networked alumino-silicate materials. Unlike conventional organic polymers, glass, ceramic or cement, geopolymers are non-combustible, heat-resistant, formed at low temperatures, and fire/acid resistant. In more particular, the present claimed invention relates to a method for coating a geopolymer onto the article, the geopolymer has high fire and erosion resistance and high mechanical strength. This fly ash-based porous geopolymer shows increased strength after temperature exposure. Geopolymerization involves a chemical reaction between various aluminosilicate oxides with silicates under highly alkaline conditions.

According to the preferred embodiment of the present claimed invention, a method for coating a geopolymer onto an article made of high heat applicable material is disclosed. The method comprising the steps of providing geopolymer paste prepared from reacting fly ash- derived pozzolanic material with an alkaline activator solution; coating the geopolymer paste onto the article; curing the coated article to harden the polymer by cross-linking polymer chains throught the use of chemical additive, ultraviolet radiation, electron beam or heat; and sintering the cured article at a temperature ranging from 100° C. to 1500° C. The article is made of concrete, clay, ceramic, metal, alloy, or other high heat applicable material.

According to one of the embodiments of the present claimed invention, the fly ash-derived pozzolanic material as disclosed contains alumino-silicate and is preferred to be a dry, low calcium and Class F fly ash. The presence of calcium in fly ash in significant quantities can interfere with the polymerization setting rate and alter the microstructure. Therefore, the use of Low Calcium (Class F) fly ash is preferred over High Calcium (Class C) fly ash as a source material to make geopolymers. Fly ash is a burnt and powdery derivative of inorganic mineral matter that generates during the combustion of pulverized coal in the thermal power plant. Owing to its pozzolanic property, fly ash is preferred to be used in geopolymer production due to its hydraulic or self-cementing property. The type of application of a geopolymer is determined by the chemical structure in terms of the atomic ratio of silicate to aluminum. A low ratio of Si:Al (up to a 3:1 ratio) initiates a 3D network that is very rigid and has high fire and heat resistance, while Si:Al ratio higher than 15:1 provides a polymeric character to the geopolymer. The fly ash-derived pozzolanic material has a preferred molar ratio between silicate to aluminium of 3.5:1 due to its promising fire resistant characteristics and capability of exhibiting strong adhesion to surfaces. The fly ash-derived pozzolanic material can be oil palm fly ash, volcanic fly ash or any other fly ash.

The smaller the particle size of the starting material, the higher the reactivity and the geopolymerization rate will be. The fine particle size of fly ashes is appropriate for the synthesis of geopolymers.

In another embodiment of the present claimed invention, the alkaline activator solution is formed by sodium silicate and sodium hydroxide. Alkali activation of fly ashes is a procedure by which the grey powder resulting from the coal combustion is mixed with alkaline activators and the resultant paste is cured under mild temperatures to produce hardened materials. The mechanism of activation of fly ash can be divided into two stages: dissolution and polymerization. In the first stage, alumino-silicate oxide is dissolved in alkali solution, forming a series of complex ionic species. The dissolved Al and Si complexes diffuse from particle surfaces to the interparticle space. During polymerization, the Al and Si complexes in the dissolution join an added silicate solution to form large molecules that precipitate in the form of gel. Hardening of the gel phase by exclusion of excess water forms the geopolymeric product.

The reaction of alumino-silicate materials in a strong alkaline environment results in a breakdown of Si—O—Si bonds. The penetration of Al atoms into the original Si—O—Si structure leads to the formation of alumino-silicate gels.

Alternatively, the alkaline activator solution can be formed by water glass (sodium silicate) and any alkali hydroxide such as potassium silicate and potassium hydroxide respectively. Preferably, the sodium silicate consists of 8-10% of sodium oxide, 25-35% of silicon dioxide and 55-65% of water. Most preferably, the sodium silicate consists of 9.4% of sodium oxide, 30.1% of silicon dioxide and 60.5% of water. The sodium hydroxide is preferred to be in pellet form with a 97% purity. The alkaline activator solutions are preferred to be prepared by dissolution of the sodium hydroxide in one liter of distilled water and subsequently mixed with the sodium silicate.

In yet another embodiment of the present claimed invention, the concentration ratio between fly ash-derived pozzolanic material to alkaline activator is 2.5-3.5:1. Preferably, the concentration ratio between the fly ash-derived pozzolanic material to alkaline activator is 3.5:1. Surface deterioration of frequently exposed articles such as metal, clay or concrete is a major problem because of loss of surface cover caused by corrosion, heat, or abrasion and tends to cause reinforcement failure.

Fly ash-based geopolymer exhibits high compressive strength, is resistant to chemical and heat attack, and is cost efficient in production. The geopolymer paste as described herein is a protective coating material suitable to be used as a refractory material. The geopolymer paste cures to a glassy texture and is subsequently subjected to the sintering process at a temperature range from 100° C. up to 1500° C. The sintered geopolymer coated article is capable of withstanding a temperatures ranging from 600° C. to 1800° C.

In another embodiment of the present claimed invention, the method further comprises providing clay-based pozzolanic material, volcano mud-based pozzolanic material, marine clay-based pozzolanic material or a combination thereof to the fly ash-derived pozzolanic material prior to reacting with the alkaline activator solution. The fly ash-derived pozzolanic material can be mixed with clay, ground-granulated blast-furnace slag (GGBS), marine clay, and/or volcano mud to produce the geopolymer paste.

Still another embodiment of the present claimed invention describes that the alkaline activator solution is formed by a sodium silicate and a sodium hydroxide. Preferably, the concentration ratio between sodium silicate to sodium hydroxide ranges from 2.5:1 to 3.5:1, most preferably, 3.5:1. The ratio of 3.5:1 between sodium silicate to sodium hydroxide produces a high compressive strength of 42.40 MPa after sintering at a temperature of 1000° C.

In another embodiment of the present claimed invention, the geopolymer coated article is cured at a temperature ranging from 40° C. to 100° C. Curing conditions have a significant effect in the mechanical strength of the coated article. Preferably, the geopolymer coated article is cured for 4 to 48 hours for synthesis of the geopolymer coat. Heat-curing of low-calcium fly ash-based geopolymers assists the chemical reaction that occurs in the geopolymer paste. Both curing time and curing temperature influence the compressive strength of the geopolymer.

In a further embodiment of the present claimed invention, the alkaline solution was added and mixed with the fly ash-derived pozzolanic material for approximately five minutes to obtain a homogeneous mixture. A foaming agent solution, such as a super-placticizer or any other types of dispersing admixture, is preferred to be added to the geopolymer paste to avoid particle aggregation and obtain a porous geopolymer concrete upon completion of the curing and sintering process. The alkaline activator solution is preferred to be prepared just before being added to the fly ash-derived pozzolanic material to ensure complete polymerization.

Lightweight concrete can be prepared by either injecting air through the use of a foaming agent, omitting the finer sizes of the aggregate or replacing them with porous aggregate. The density of lightweight concrete usually ranges from 300 to 1800 kg/m³ while the density of normal concrete is approximately 2400 kg/m³. Lightweight concrete can be categorized into three groups: no-fines concrete, lightweight aggregate concrete, and aerated/foamed concrete. Foamed concrete is produced by using either cement paste or mortar in which large volumes of air are entrapped by using a foaming agent. Such foamed concrete has high flow ability, low weight, and minimal consumption of aggregates, controlled low strength, and excellent thermal- insulation properties.

Commonly, ordinary Portland cement (OPC) is used to form foamed concrete. The cost of producing foamed concrete can be reduced by replacing OPC with fly ash. With this replacement, the long-term strength of foamed concrete is increased and the heat of hydration is reduced. Fly ash is suitable for use as a geopolymer source material because it consists mostly of glassy, hollow and spherical particles. Fly ash-based geopolymer cement and concrete are well known for their favorable properties, which are better than those of normal concrete due to their lower shrinkage, better fire and acid resistance, and resistance to sulfate attack.

In a particular embodiment of the present claimed invention, the sintering process of the cured article has heating and cooling rates ranging from 3° C./minute to 8° C./minute. The cured article is preferred to be sintered at a temperature ranging from 100° C. to 1500° C. for approximately three hours and under the heating and cooling rates of 5° C./minute.

Sintering is effective when the process reduces the porosity and enhances properties such as strength, electrical conductivity, translucency and thermal conductivity. For properties such as strength and conductivity, the bond area in relation to the particle size is the determining factor. The variables that can be controlled for any given material are the temperature and the initial grain size, because the vapor pressure depends upon temperature. Control of temperature is very important to the sintering process, since grain-boundary diffusion and volume diffusion rely heavily upon temperature, the size and distribution of particles of the material, the material's composition, and the sintering environment to be controlled.

Hereinafter, the geopolymer coating is potentially suitable to be used as a protective coating material, a refractory paint, a toxic immobilization solution and a decorative paint with high strength and corrosion resistant properties. The geopolymer paste can be formed onto articles by any techniques including spraying, painting, or dipping. The geopolymer paste can be applied on articles made of ceramic, metal or concrete that is exposed to high heat and chemicals in applications such as pressure vessel liners and transportation structures.

The present disclosure includes those disclosed in the claims below, as well as that of the foregoing description. Although this claimed invention has been described in its preferred form with a degree of particularity, it is understood that the present disclosure of the preferred form has been made only by way of example and that numerous changes in the details of construction and the combination and arrangements of parts may be resorted to without departing from the scope of the claimed invention.

### Example

An example is provided below to illustrate different aspects and embodiments of the present claimed invention. The example is not intended in any way to limit the disclosed claimed invention.

TABLE 1

| Concentration | Compressive Strength at | | | |
|---|---|---|---|---|
| ratio of | Third Day of Experiment | | | |
| sodium silicate and | Unsintered | 600° C. | 800° C. | |
| sodium hydroxide | (MPa) | (MPa) | (MPa) | 1000° C. (MPa) |
| 2.5 | 12.12 | 10.41 | 8.90 | 8.63 |
| 3.0 | 15.56 | 10.04 | 24.00 | 22.83 |
| 3.5 | 21.99 | 14.63 | 24.33 | 42.40 |

Referring to Table 1, an example is provided to describe the effect on the compressive strength of the geopolymer-cured samples when not subjected to sintering and when subjected to the sintering process at three different temperatures. The compressive strengths of the porous geopolymer-cured samples were measured using a mechanical testing machine, Automatic Max (Instron, 5569 USA). The samples were tested for three days after the sintering process. Physical observations showed de-colorization of all samples. The compressive strengths of the porous geopolymer samples, before and after exposure to the high sintering temperature, are shown in the table. The three sodium silicate and sodium hydroxide solutions range in concentration ratios from 2.5:1 to 3.0:1 to 3.5:1.

The compressive strength of the geopolymer significantly improved with an increase in the sintering temperature and as the ratios increased. An increase in the sodium silicate and sodium hydroxide concentration ratios resulted in an increase in the sodium content of the alkaline activator and geopolymer mixture, which, in turn, exhibited more stable strength properties. Rapid strengthening occurred within the geopolymer samples with higher concentrations of sodium hydroxide, especially within the sodium silicate. The sample having the sodium silicate to sodium hydroxide concentration ratio of 3.5:1 showed the highest compressive strength of 42.40 MPa with the highest sintering temperature, 1000° C., compared to the other three samples.

What is claimed is:

1. A method of coating a geopolymer onto an article that is made of a high heat applicable material, the method comprising the steps of:
providing a geopolymer paste prepared from reacting a fly ash-derived pozzolanic material with an alkaline activator solution;
coating the geopolymer paste onto the article;
curing the article coated with the geopolymer paste; and
sintering the article which has been cured at a temperature ranging from 100° C. to 1500° C.

2. The method according to claim 1, further comprising:
providing at least one of a clay-based pozzolanic material, a volcano mud-based pozzolanic material, a marine clay-based pozzolanic material or a combination thereof to the fly ash-derived pozzolanic material prior to reacting with the alkaline activator solution.

3. The method according to claim 1, wherein:
the high heat applicable material is at least one of concrete, clay, ceramic, metal, and an alloy.

4. The method according to claim 1, wherein:
the concentration ratio between the fly ash-derived pozzolanic material to the alkaline activator is a ratio in the range of 2.5-3.5 to 1.

5. The method according to claim 1, wherein:
the alkaline activator solution comprises a sodium silicate solution and a sodium hydroxide solution.

6. The method according to claim 5, wherein:
the sodium silicate solution consists of 8-10% of sodium oxide, 25-35% of silicon dioxide, and 55-65% of water.

7. The method according to claim 1, wherein:
the coated article is cured at a temperature ranging from 60° C. to 75° C.

8. The method according to claim 1, wherein:
the sintering process of the article which has been cured comprises heating the article at a rate of 3° C./minute to 8° C./minute and cooling the article at a rate of 3° C./minute to 8° C./minute.

9. The method according to claim 1, wherein:
the article which has been sintered has a compressive strength ranging from 14 MPa to 45 MPa.
